(19) United States
(12) Patent Application Publication
(10) Pub. No.: US 2006/0124747 A1
(43) Pub. Date: Jun. 15, 2006

(54) Protective envelope for a chip card

(76) Inventors: Irwin D. Rathbun, Colorado Springs, CO (US); Gayle W. Miller, Colorado Springs, CO (US)

Correspondence Address: SCHNECK & SCHNECK, P.O. BOX 2-E, SAN JOSE, CA, 95109-0005, US

(21) Appl. No.: 11/008,421

(22) Filed: Dec. 9, 2004

(51) Int. Cl. G06K 7/00

(52) U.S. Cl. 235/486

(57) ABSTRACT

A protective envelope for a chip card wherein a fabric sheath with a top flap allows entry of the chip card. An inner Faraday cage, nested within the fabric sheath, made of wire mesh or thin foil prevents electromagnetic fields from penetrating the sheath once the top flap is closed on the sheath body.

### TECHNICAL FIELD

The invention relates to electronic shielding and, in particular, to shielding for a wallet-size chip card.

### BACKGROUND ART

Wallet-size chip cards are ubiquitous, serving almost like common currency for telephone charges, meals, library transactions, and so on. In some of these instances, the chip card represents value and such value can be lost by accidental or malicious erasure. Since chip cards have a wallet-size form factor, they are frequently carried in clothing pockets where accidental or malicious erasure is possible by strong local magnetic fields. It is possible that a strongly magnetized magnetic stripe card in close contact with a chip card could cause accidental erasure.

An object of the invention was to provide an apparatus for shielding chip cards from accidental or malicious erasure.

### SUMMARY OF THE INVENTION

The above object has been achieved with a protective envelope for a chip card of the type having opposed major surfaces. The envelope is a sheath having a fabric skin and an interior that incorporates a Faraday cage that is attached to or is part of the sheath, surrounding major surfaces of the card. Once inserted within the Faraday cage, the chip card is electromagnetically shielded against accidental or malicious erasure.

### BRIEF DESCRIPTION OF THE DRAWINGS

FIG. 1 is a perspective view of a chip card and protective envelope of the present invention.

FIG. 2 is a side cutaway view taken along lines 2-2 in FIG. 1.

### BEST MODE FOR CARRYING OUT THE INVENTION

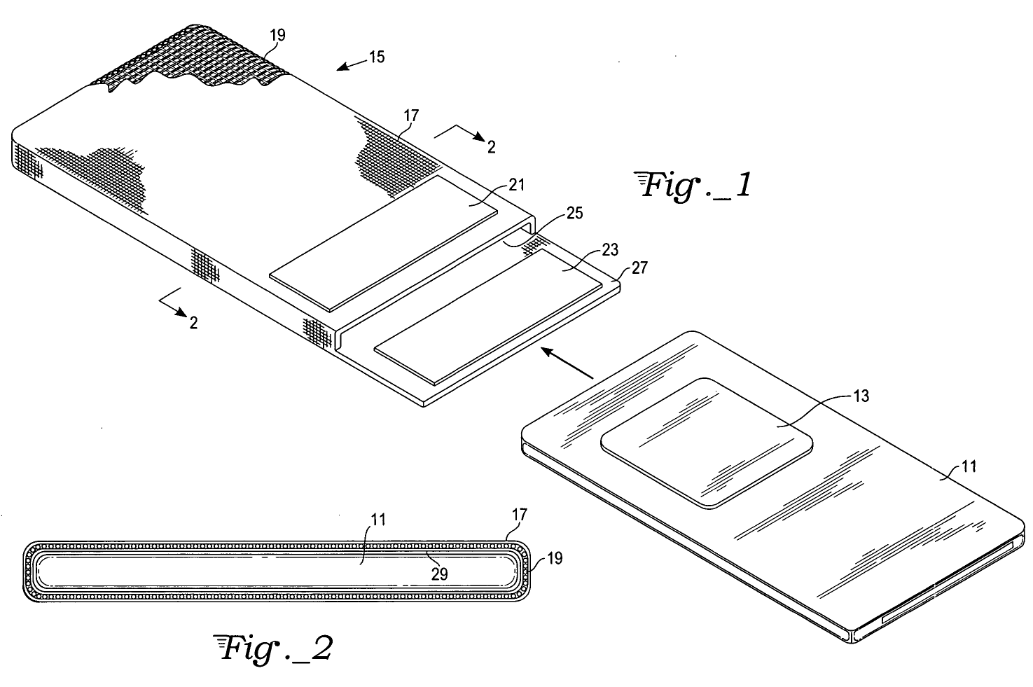

With reference to FIG. 1, a wallet-size chip card 11 is shown having semiconductor chip 13 either embedded in the card or mounted on one of the opposed major surfaces of the card. For purposes of illustration, the chip 13 is shown atop a major surface of the card 11, but in most instances, the chip would be protectively positioned within the card. The size of the chip may vary from approximately one millimeter to a centimeter on a side to somewhat larger dimensions. The chip receives power inductively or by contact with probe wires but, because it employs non-volatile memory, transistors on the chip remain in a particular state even when power is removed. To read the chip card, the card is specifically placed in a reader that makes contact with the chip, either directly by means of a probe wire or electromagnetically. A similar apparatus is used to write on the card. In the meantime, between reading and writing, the card is transported by a holder, typically in a pocket or purse where an external electromagnetic field can penetrate the chip and cause a loss of data.

To prevent loss of data, the card 11 is placed endwise into a protective sheath 15. The sheath has an outer skin that is exemplified by fabric 17 which may either be woven or non-woven material. A typical woven outer fabric 17 is cloth, such as cotton or a synthetic material. A typical non-woven outer fabric 17 could be a self-supporting plastic or rubber material. The outer fabric 17 is associated with an inner wire mesh 19, or a metal foil, or vapor-deposited layer, which forms a Faraday cage on the interior of the sheath. The wire mesh may be sewn or bonded. In order to form a Faraday cage, the wire mesh must be electrically conductive, preferably made of copper, aluminum, silver, gold, or ferromagnetic wire. Alternatively, two wire mesh layers may be used, slightly spaced apart from each other, namely a ferromagnetic mesh layer and a mesh layer having electrical conductivity at least as good as aluminum. The mesh is finer than typical screen door screening with a grid pattern which is typically twice as fine as that found in good quality commercial screen doors. Electromagnetic waves encountering wire mesh 19 will be restricted to the surface of the wire and generally would not penetrate the wire mesh.

The wire mesh may be embedded within the outer fabric 17 or may be attached to it as a laminar member. Another alternative is to form a sandwich construction with the wire between nesting fabric sheaths, as seen in FIG. 2 where inner fabric sheath 29 keeps wire mesh 19 from contacting the card 11. The latter structure will prevent the wire mesh from scratching the card. Sheath 15 is seen is have a top flap 27 which forms a closure after card 11 is inserted into the sheath through opening 25. A pair of Velcro strips 21 and 23 allow the top flap 27 to close the sheath.

As an alternative to wire mesh, a metal layer could be used, such as a metal foil, or a vapor deposited metal layer. Although it is possible for very strong electromagnetic fields to penetrate into a Faraday cage, most ordinary electromagnetic fields will not penetrate the cage and so the card 11 will be protected from accidental or malicious erasure. A metal foil could be aluminum foil. A vapor deposited foil must be on a skin having a high temperature characteristic so that the skin will not be damaged during vapor deposition.

Inner fabric sheath 29 may employ the same fabric material as outer fabric 17, or use different material. Non-woven inner and outer fabric sheaths 17 and 27, when made of plastic, may be bonded together with heat encapsulating wire mesh 19 to form a unitary structure.

1. A protective envelope for a chip card comprising, a fabric sheath having an opening accommodating a chip card therein, and a metal Faraday cage material is disposed within the fabric of the protective envelope in a manner wherein the Faraday cage material does not contact the card.

2. The envelope of claim 1 wherein the Faraday cage material is a wire mesh layer made of a material selected from the group consisting of copper, aluminum, silver, and gold.

3. The envelope of claim 1 wherein the Faraday cage material is wire mesh made of a ferromagnetic material.

4. The envelope of claim 1 wherein the Faraday cage material is made of two metal layers spaced apart from each other.

5. The envelope of claim 1 wherein the Faraday cage material is a first wire mesh layer of electrical conductivity at least as good as aluminum and a second wire mesh layer, spaced from the first wire mesh layer and made of a ferromagnetic material.

6. The envelope of claim 1 wherein the Faraday cage material is metal foil.

7. The envelope of claim 1 wherein the Faraday cage material is aluminum foil.

8. The envelope of claim 1 wherein the Faraday cage material is embedded within said fabric.

9. The envelope of claim 1 wherein the Faraday cage material is a layer sandwiched between two fabric laminar layers.

10. A protective envelope for a chip card comprising a non-woven sheath with an outer skin and a core, the sheath having an opening admitting a wallet-size card with opposed major surfaces, the sheath core having a Faraday cage disposed in non-contacting relation relative to the card to surround the major surfaces of the card.

11. The envelope of claim 10 wherein the Faraday cage is integral with the sheath.

12. The envelope of claim 10 wherein the Faraday cage is sandwiched between two non-woven layers.

13. The envelope of claim 10 wherein the Faraday cage is bonded to the outer skin.

14-18. (canceled)

19. The envelope of claim 10 wherein the Faraday cage is a metal foil.

20. The envelope of claim 19 wherein the Faraday cage is an aluminum foil.

21. The envelope of claim 19 wherein the Faraday cage is a vapor deposited layer.

22. (canceled)
